(19) United States
(12) Patent Application Publication
(10) Pub. No.: US 2015/0167684 A1
(43) Pub. Date: Jun. 18, 2015

(54) FAN TESTING SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XIN-SHU WANG, Wuhan (CN); MIN YANG, Wuhan (CN); JIAN-HUNG HUNG, New Taipei (TW)

(21) Appl. No.: 14/522,916

(22) Filed: Oct. 24, 2014

(30) Foreign Application Priority Data
Dec. 13, 2013 (CN) 201310679975.7

(51) Int. Cl. F04D 27/00; G01P 3/00

(52) U.S. Cl. CPC F04D 27/001; G01P 3/00

(57) ABSTRACT

A fan testing system includes a computer, a testing module, and a fan. The fan includes a fan body and a controller. The testing module includes a storing unit and an executing unit. The storing unit stores a reference range value, a standard speed control value, and a standard speed value. The executing unit sends the standard speed control value to the controller. The controller drives the fan body to rotate, get a current speed value, and sends the current speed value to the executing unit. The executing unit outputs pass information to the computer after determining a difference value between the current speed value and determining if the standard speed control value is within the reference range value. The executing unit outputs failed information to the computer upon the determining that the difference value exceeds the reference range value. A fan testing method is also provided.

### CROSS-REFERENCE TO RELATED APPLICATIONS

This application claims priority to Chinese Patent Application No. 201310679975.7 filed Dec. 13, 2013, the contents of which are incorporated by reference herein.

### FIELD

The subject matter herein generally relates to testing systems and testing methods for fans.

### BACKGROUND

A fan testing system and a fan testing method is configured to test rotation speeds of a fan.

### BRIEF DESCRIPTION OF THE DRAWINGS

Implementations of the present technology will now be described, by way of example only, with reference to the attached figures.

FIG. 1 is a block diagram of one embodiment of a fan testing system.

FIGS. 2 and 3 illustrate a flowchart of one embodiment of a fan testing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein.

However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections.

The connection can be such that the objects are permanently connected or releasably connected. The term “comprising,” when utilized, means “comprising, but not necessarily limited to”; it specifically indicates open-ended inclusion or membership in the so-described combination, group, series, and the like.

The present disclosure is described in relation to a fan testing system and a fan testing method.

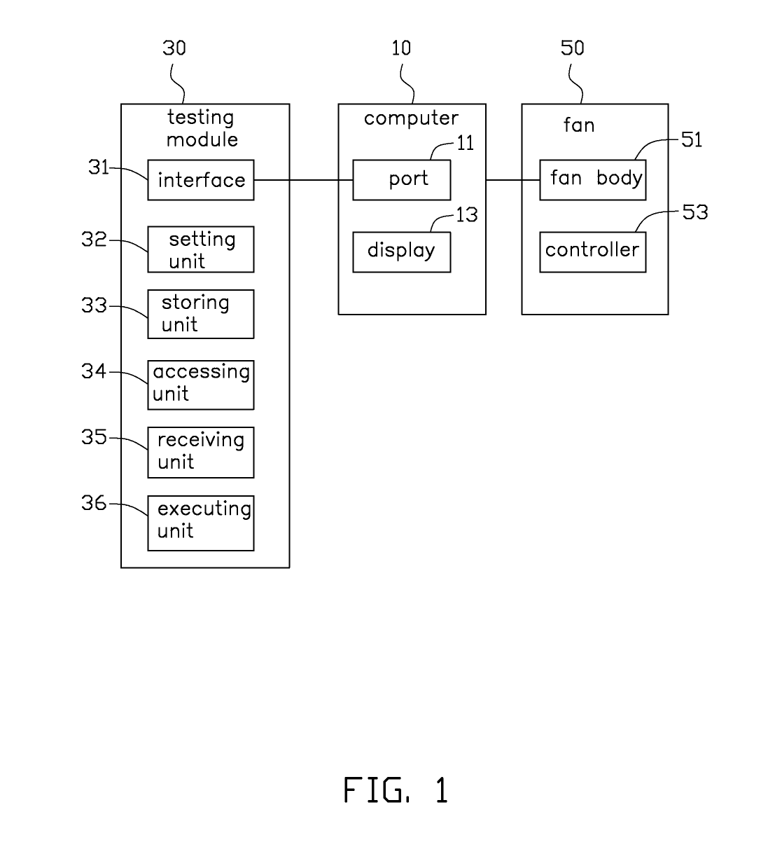

FIG. 1 illustrates an embodiment of a fan testing system. The fan testing system comprises a computer 10, a testing module 30 coupled to the computer 10 and a fan 50. The computer 10 comprises a port 11 and a display 13. The display 13 is configured to display a testing result. In one embodiment, the port 11 is a low pin count input/output (LPC I/O) port.

The fan 50 comprises a fan body 51 and a controller 53. The fan body 51 is configured to be inserted into the computer 10. The controller 53 is mounted in the fan body 51 and is configured to control the fan body 51 to rotate. The controller 53 stores basic information corresponding to the fan body 51. The basic information comprises a serial-number of the fan body 51 and serial-number of the controller 53. In one embodiment, the controller 53 may be an embedded controller (EC) or a Super I/O.

The testing module 30 comprises an interface 31, a setting unit 32, a storing unit 33, a accessing unit 34, a receiving unit 35, and an executing 36. The testing module 30 communicates with the fan 50 via the interface 31 and the port 11. The setting unit 32 is configured to set a reference range value and a standard parameter. The storing unit 33 stores the reference range value and the standard speed value. The standard parameter includes a plurality of standard speed control values and a plurality of standard speed values. Each standard speed control value is a pulse width modulation (PWM) signal value. Each standard speed value is a TACH signal value. The standard speed control values are configured to control the fan body 51 to rotate. The standard speed values are speeds of the fan body 51 when the fan body 51 rotates. The executing unit 36 is configured to output testing results to the display 13. The display 13 is configured to display the testing results. Each testing result comprises pass information and failed information.

The computer 10 and the fan 50 are turned on and running the testing module 30 when the fan 50 is tested.

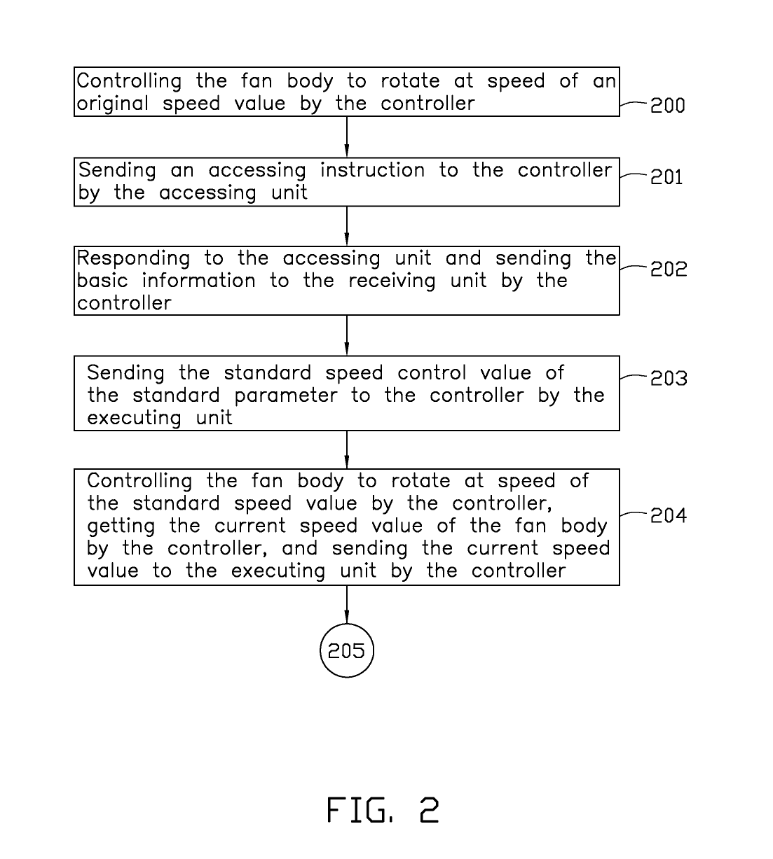

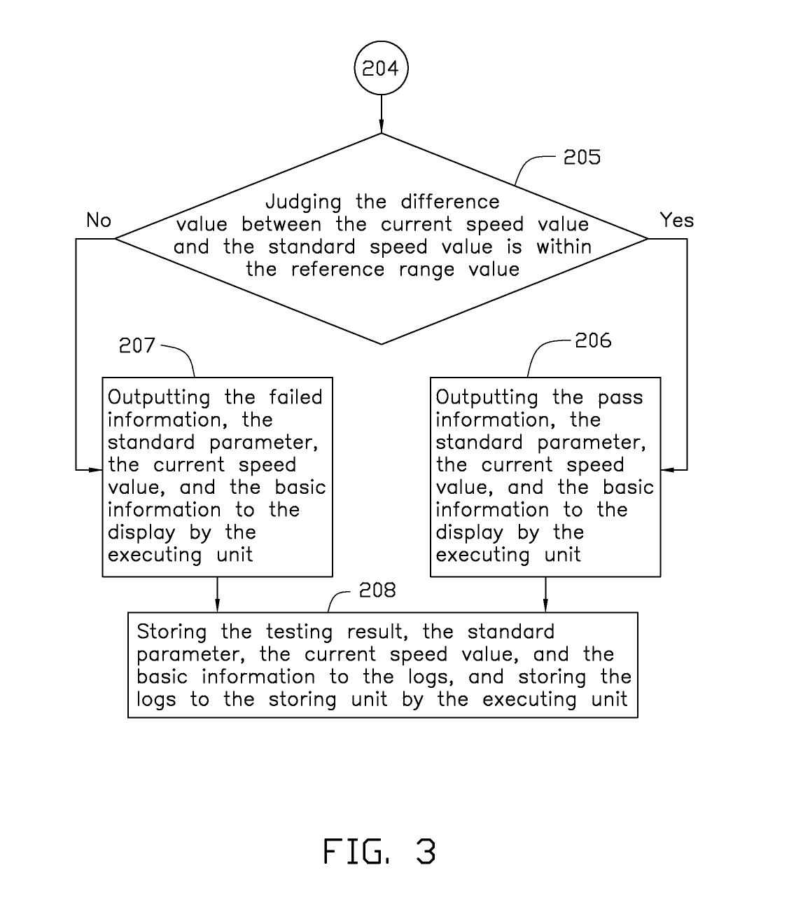

FIGS. 2 and 3 illustrate a flowchart in accordance with an example embodiment. A fan testing method is provided by way of example, as there are a variety of ways to carry out the method. The fan testing method described below can be carried out using the configurations illustrated in FIG. 1, for example, and various elements of these figures are referenced in explaining fan testing method. In FIGS. 2 and 3 each block represents one or more processes, methods, or subroutines carried out in the voice-recognition method. Additionally, the illustrated order of blocks is by example only and the order of the blocks can change. The fan testing method can begin at step 200.

In step 200, the controller 53 controls the fan body 51 to rotate at original speed value.

In step 201, the accessing unit 34 sends an accessing instruction to the controller 53.

In step 202, the controller 53 responds to the accessing unit 34 and sends the basic information to the receiving unit 35.

In step 203, the executing unit 36 sends the standard speed control value of the standard parameter to the controller 53.

In step 204, the controller 53 controls the fan body 51 to rotate at a standard speed value, gets the current speed value of the fan body 51, and sends the current speed value to the executing unit 36.

In step 205, the executing unit 36 determines the difference value between the current speed value and the standard speed value whether is within the reference range value, if yes, the flow goes to step 206; and if no, the flow goes to step 207.

In step 206, the executing unit 36 outputs pass information, the standard parameter, the current speed value, and the basic information to the display 13.

In step 207, the executing unit outputs failed information, the standard parameter, the current speed value, and the basic information to the display 13.

In step 208, the executing unit 36 stores the test result, the standard parameter, the current speed value, and the basic information to the logs, and stores the logs to the storing unit 33.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A fan testing system comprising:
a testing module storing a reference range value, a standard speed control value, and a standard speed value, and
a fan having:
a fan body, and
a controller,
wherein the testing module is configured to send the standard speed control value to the controller;
the controller is configured to drive the fan body to rotate according to the standard speed control value, get a current speed value of the fan body, and send the current speed value to the testing module;
the testing module is configured to output pass information to a computer after determining a difference value between the current speed value and determining if the standard speed control value is within the reference range value; and
the testing module is further configured to output failed information to the computer upon the determining that the difference value exceeds the reference range value.

2. The fan testing system of claim 1, wherein the controller controls the fan body to rotate at speed of an original speed value before receiving the standard speed control value.

3. The fan testing system of claim 2, wherein the testing module comprises an executing unit, the executing unit sends the standard speed control value to the controller, outputs pass information to the computer after determining the difference value is within the reference range value, and outputs the fail information to the computer.

4. The fan testing system of claim 3, wherein the testing module further comprises a storing unit storing, the storing unit storing stores the reference range value, the standard speed control value, and the standard speed value.

5. The fan testing system of claim 4, wherein the testing module further comprises an interface, the computer comprises a port, and the testing module communicates with the fan via the interface and the port.

6. The fan testing system of claim 5, wherein the port is a LPC I/O port.

7. The fan testing system of claim 5, wherein the computer further comprises a display, the display is configured to display pass information and failed information.

8. A fan testing system comprising:
a computer,
a testing module having:
a storing unit storing unit stores a reference range value, a standard speed control value, and a standard speed value, and
an executing unit; and
a fan having:
a fan body, and
a controller,
wherein the executing unit is configured to send the standard speed control value to the controller; the controller is configured to drive the fan body to rotate according to the standard speed control value, get a current speed value of the fan body, and sends the current speed value to the executing unit; the executing unit is configured to output pass information to the computer to display after determining a difference value between the current speed value and determining if the standard speed control value is within the reference range value; and the executing unit is configured to output failed information to the computer upon the determining that the difference value exceeds the reference range value.

9. The fan testing system of claim 8, wherein the controller controls the fan body to rotate at speed of an original speed value before receiving the standard speed control value.

10. The fan testing system of claim 8, wherein the testing module further comprises an interface, the computer comprises a port, and the testing module communicates with the fan via the interface and the port.

11. The fan testing system of claim 10, wherein the port is a LPC I/O port.

12. A fan testing method comprising:
sending a standard speed control value to the controller by the testing module;
controlling the fan body to rotate at speed of the standard speed value by the controller, getting the current speed value of the fan body by the controller, and sending the current speed value to the executing unit by the controller;
determining a difference value between the current speed value and the standard speed value is within the reference range value and outputting pass information, the standard parameter, the current speed value, and the basic information to the display by the executing unit; and
determining the difference value exceeds the reference range value and outputting failed information, the standard parameter, the current speed value, and the basic information to the display by the executing unit.

13. The fan testing method of claim 12, further comprises a step of controlling the fan body to rotate at speed of an original speed value before receiving the standard speed control value by the controller.

14. The fan testing method of claim 12, further comprises a step of sending the standard speed control value to the controller by the testing module before sending accessing information to the controller.

15. The fan testing method of claim 14, further comprises a step of responding and sending the standard speed control value to the testing module by the controller after receiving the accessing information.

16. The fan testing method of claim 14, further comprises a step of storing pass information, failed information, the standard parameter, the current speed value, and the basic information by the testing module.
